(19) United States
(12) Patent Application Publication
(10) Pub. No.: US 2004/0231173 A1
(43) Pub. Date: Nov. 25, 2004

(54) Adjustable ruler guide

(76) Inventor: Marcia L. Baker, Fort Collins, CO (US)

Correspondence Address: COCHRAN FREUND & YOUNG LLC, 3555 STANFORD ROAD, SUITE 230, FORT COLLINS, CO, 80525, US

(21) Appl. No.: 10/851,348

(22) Filed: May 21, 2004

Related U.S. Application Data
(60) Provisional application No. 60/472,708, filed on May 21, 2003.

(51) Int. Cl. B43L 13/02

(52) U.S. Cl. 33/42

(57) ABSTRACT

A guide for cutting or marking a piece of fabric or other laminate material has a movable stop that may attach to the guide using static attraction. The stop may be repositioned for cutting or marking different sized pieces. The assembled stop and guide may be placed over the edge of the fabric so that the stop engages the edge in a repeatable and reliable manner. The guide may be a rectangular polycarbonate ruler while the stop is a rectangular strip of polyvinylchloride sheet. Other embodiments may use different shaped guides and stops to achieve different shapes of the cut or marked fabric.

### CROSS REFERENCE TO RELATED APPLICATIONS

The present application is based upon and claims the benefit of U.S. Provisional Patent Application Serial No. 60/472,708 for “Adjustable Ruler Guide” which was filed on May 21, 2003, the entire contents of which is hereby specifically incorporated by reference herein for all that it discloses and teaches.

### BACKGROUND OF THE INVENTION

a. Field of the Invention

The present invention pertains to cutting cloth and other materials and, more specifically, to an adjustable guide for aligning a cutting or marking instrument.

b. Description of the Background

The construction of quilts or sewn articles often requires the repetitive cutting of fabric into strips of a particular width. The strips may then be assembled in various patterns to create a quilt or other sewn article.

Various rulers exist for guiding a marking or cutting instrument for making the required strips of fabric. Such rulers are commonly rectangular in shape and made from polycarbonate or other clear plastic. The rulers typically have parallel lines or markings running parallel to the long side of the ruler. This allows a user to place the ruler on top of a piece of fabric, look through the ruler to visually align an edge of the fabric with a marking or graduation on the ruler, and use the edge of the ruler that overlaps the fabric as a cutting or marking guide. The ruler may then be moved to the next location and the process repeated.

When many cutting operations are required, each repositioning of the ruler requires a visual alignment of the edge of the fabric to one of the graduations of the ruler. Each visual alignment is an opportunity for error. When the material is a similar color as the work surface, it may be difficult for the user to detect the actual edge of the fabric. Additionally, the ruler may have several markings that are parallel and similar in thickness, causing the user to refer to graduations and carefully read the ruler in order to position the ruler properly.

It would therefore be advantageous to provide a method and apparatus for guiding a marking or cutting operation wherein the guide may be placed accurately and quickly. It would be further advantageous if the apparatus were easily configured for different cutting operations.

### SUMMARY OF THE INVENTION

The present invention overcomes the disadvantages and limitations of the prior art by providing a system and method for aligning a clear plastic ruler to an edge of a piece of fabric using a piece of statically attractive plastic as a removable edge guide. The edge guide may be placed on the ruler aligned with specific graduations and then used to position the ruler to the fabric edge.

The present invention may therefore comprise a method for cutting laminar material including: attaching a stop having an alignment edge to the bottom surface of a guide having a substantially planar bottom surface and a guiding edge, at a chosen position; placing the guide on top of the laminar material; adjusting the position of the guide such that the alignment edge of the stop engages at least a portion of an edge of the laminar material; and cutting the laminar material along at least a portion of the guiding edge.

The present invention may further comprise an apparatus for guiding a cutting device for laminar material having an edge including: a guide having a substantially planar bottom surface and a guiding edge; and a stop having an alignment edge adapted to align with the edge of the laminar material, wherein the stop is adapted to attach to the bottom surface of the guide at a predetermined position such that at least a portion of the guiding edge of the guide is used to guide the cutting device.

The present invention may still further comprise an apparatus for marking laminar material having an edge including: a guide having a substantially planar bottom surface and a marking edge; and a stop having an alignment edge adapted to align with the edge of the laminar material, wherein the stop is adapted to attach to the bottom surface of the guide at a predetermined position such that at least a portion of the marking edge of the guide is used to mark the laminar material.

The advantages of the present invention are that marks or cuts along the edge of a piece of fabric may be made quickly and repeatedly with a high degree of accuracy. Many marks or cuts may be made without having to visually align a ruler or straight edge for the operation.

### BRIEF DESCRIPTION OF THE DRAWINGS

In the drawings,

FIG. 1 is a schematic representation of a bottom view of an embodiment of the adjustable guide of the present invention.

FIG. 2 is a schematic representation of a top view of the embodiment of the adjustable guide illustrated in FIG. 1 hereof, shown guiding a cutting device for cutting a strip of sheet material over the sheet material.

FIG. 3 is a schematic representation of a bottom view of an embodiment of the adjustable guide of the present invention suitable for guiding a cutting device or a marking device over a selected curved or shaped pattern.

FIG. 4 is a schematic representation of the top view of the embodiment of the adjustable guide of the illustrated in FIG. 3 hereof, shown guiding a cutting device for cutting sheet material over the sheet material.

FIG. 5 is a schematic representation of the bottom view of an embodiment of the adjustable guide of the present invention showing details on the non-functional edges of the adjustable stop.

### DETAILED DESCRIPTION OF THE INVENTION

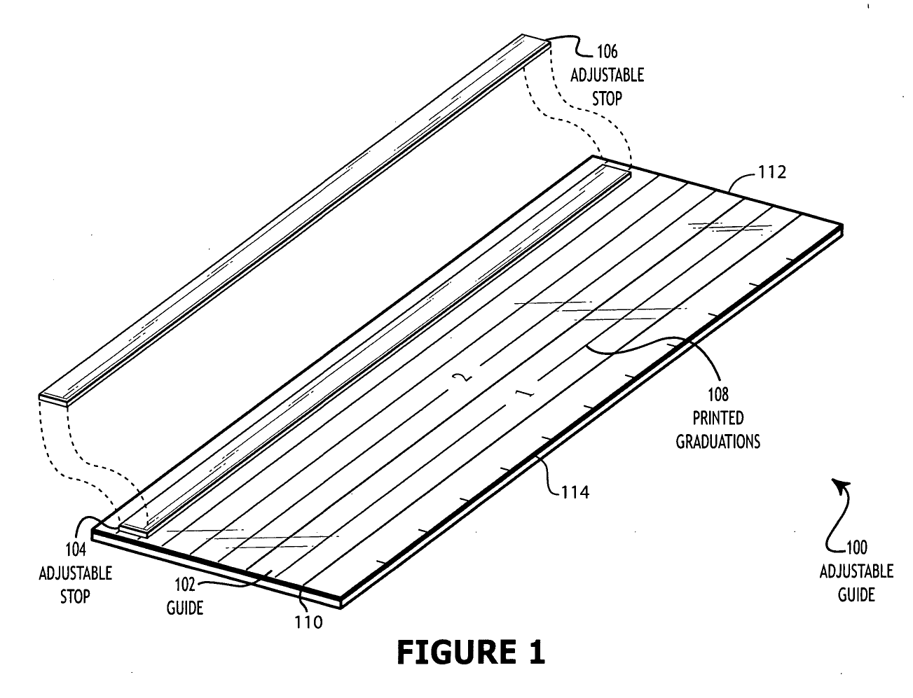

FIG. 1 is a schematic representation of a bottom view of an embodiment of the adjustable guide 100 of the present invention. Guide 102 has adjustable stop 104 attached thereto. Adjustable stop 106 is shown removed from guide 102. Guide 102 may have printed graduations 108 that may aid a user in correctly positioning adjustable stop 106. Although shown in a rectangular geometry, having sides 110 and 112, and base 114, guide 102 have many forms. In particular, sides 110 and 112 can slant toward one another forming a triangle with base 114 or a trapezoid. Graduations 108 are preferably oriented parallel to base 114.

Rectangular guide 102 may be comprised any non-porous material, but is preferably made from a transparent plastic material such as polycarbonate or other clear, tough plastic. Graduations 108 may be molded into guide 102, printed onto the surface thereof, or may be placed by any other method known in the art.

Adjustable stop 104 or 106 may be manufactured from a strip of polyvinylchloride (PVC) sheet material, typically between 0.009 in. and 0.035 in. thick when used to cut a typical woven fabric cloth material. When adjustable guide 106 is less than about 0.008 in. thick, stop 104 may not effectively engage the edge of the fabric material. When stop 104 is substantially thicker than 0.035 in., stop 104 may engage more than one thicknesses of the fabric material. Generally, an effective range of thickness for the stop is between 30% and 125% of the thickness of the material to be cut. The static adhesion of untreated PVC sheet is well known and it readily adheres to non-porous surfaces, such as polycarbonate, ceramic, polished metal, and the like.

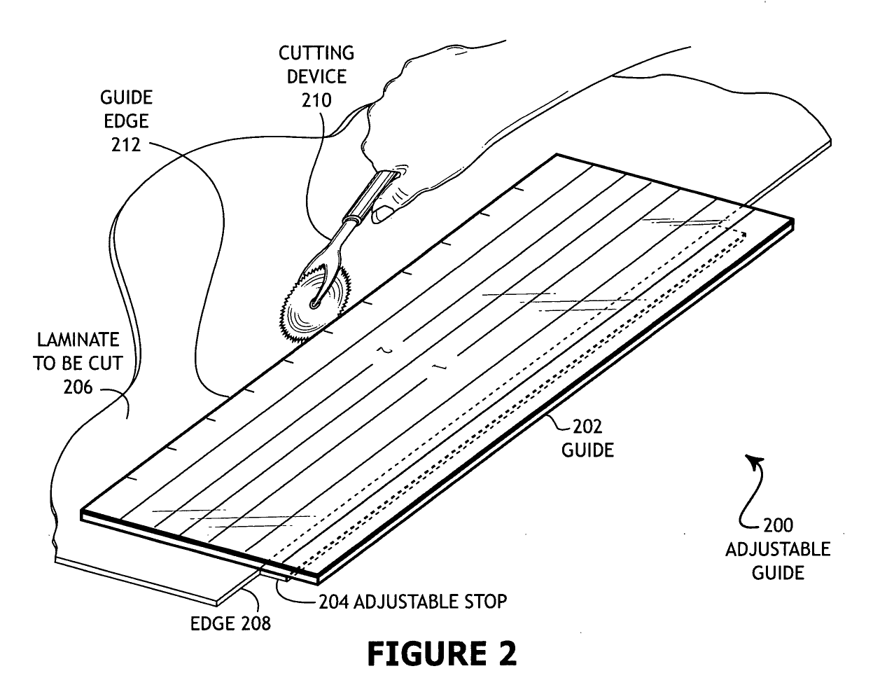

FIG. 2 is a schematic representation of a top view of the adjustable guide 200 shown in FIG. 1 hereof, that may be used to cut a strip of sheet material. Guide 202 has adjustable stop 204, and is placed over a laminate to be cut 206. Adjustable stop 204 is placed against edge 208 of laminate 206. Shown is cutting device 210 being guided by guide edge 212 of guide 202, enabling a user to make repeatable and accurate cuts or marks along the guide edge 212 of the guide block 202. The user may quickly and accurately place guide block 202 in alignment with edge 208 because adjustable stop 204 is adapted to engage the edge of laminate 206.

When guide block 202 is constructed from a transparent material, a user has an additional advantage of being able to visually inspect the alignment of edge 208 with adjustable stop 204.

In some embodiments, guide block 202 may have a handle or other protrusion (not shown) on the upper (top) side of guide block 202. Such a protrusion may assist the user in positioning the adjustable guide over the laminate.

Laminate 206 may be a sheet stock laminate such as plastic sheet, paper, metal, composite, wood, and glass, or may be a woven fabric for sewn articles such as quilts and the like. That is, the laminate may be any type of planar material that may be marked or cut. Cutting device 210 may be a circular cutter, a knife, or other cutting instrument. Additionally, cutting device 210 may be replaced with pencil, chalk, or other marking instrument.

Generally, the thickness of adjustable stop 204 is chosen such that the stop can effectively engage the edge of the material to be cut or marked, while not being so thick as to cause guide 202 to become unstable due to rocking about stop 204. Under some circumstances, it may be desirable to make stop 204 sufficiently wide to avoid this situation. Thicknesses between 30% and 125% of the thickness of laminate 206 have been used. As an example, if the laminate 206 is, say, a woven cloth material about 0.03 in. thick, adjustable stop 204 would be within the range between 0.009 in. and 0.038 in. thick. Laminates may include several sheets of material, such as several pieces of paper or fabric, to be cut simultaneously.

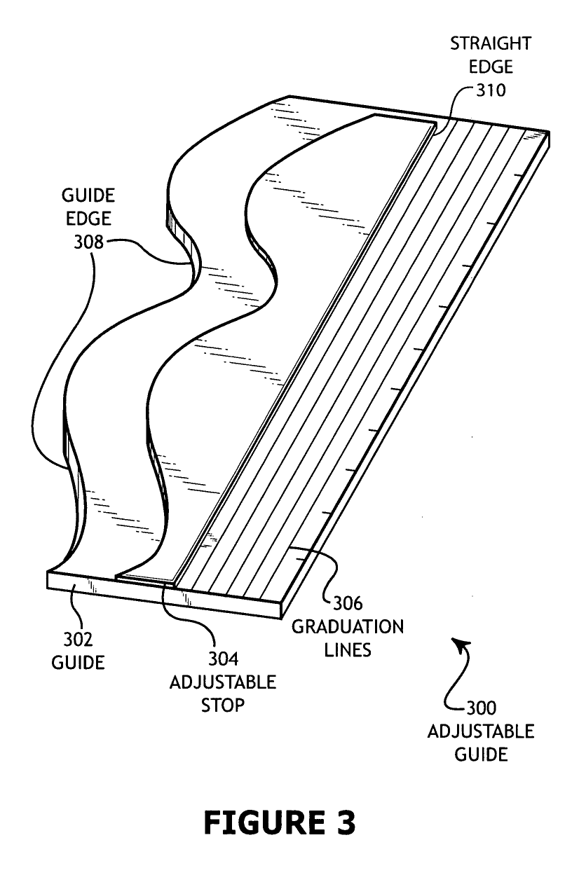

FIG. 3 is a schematic representation of the bottom view of an embodiment 300 of the adjustable guide of the present invention adapted for cutting curved or shaped strips. Guide 302 has an adjustable stop 304 attached by static attraction. Guide 302 may have several graduation marks 306 in order to aid in the placement of adjustable stop 304. Guide edge 308 of guide 302 is shown to have a curved shape, and may have a shape different from that of stop 304.

Adjustable stop 304 has a straight edge 310 that may be readily aligned with graduation lines 306 of guide 302. In FIG. 3, the curved edge of adjustable stop 304 is shown to be similar in shape to guide edge 308. Adjustable guide 300 may be used in a similar fashion to adjustable guide 200, illustrated in FIG. 2 hereof, where straight edge 310 of adjustable stop 304 is aligned with the edge of the material to be cut or marked.

In some embodiments, the adjustable stop 304 may be attached to guide 302 with static attraction or by other mechanisms. For example, adjustable stop 304 may be coated at least in part with a releasable adhesive that may be used once or reused several times. In other embodiments, a permanent adhesive may be used to attach adjustable stop 304 to guide 302 in situations where numerous repeat uses of a particular adjustable guide geometry is desired. Other permanent mechanisms may include heat fusing, mechanical fastening, such as flat-head screws being screwed into predrilled and tapped holes in the bottom of guide 302 (not shown), chemical bonding, or other mechanisms known in the art.

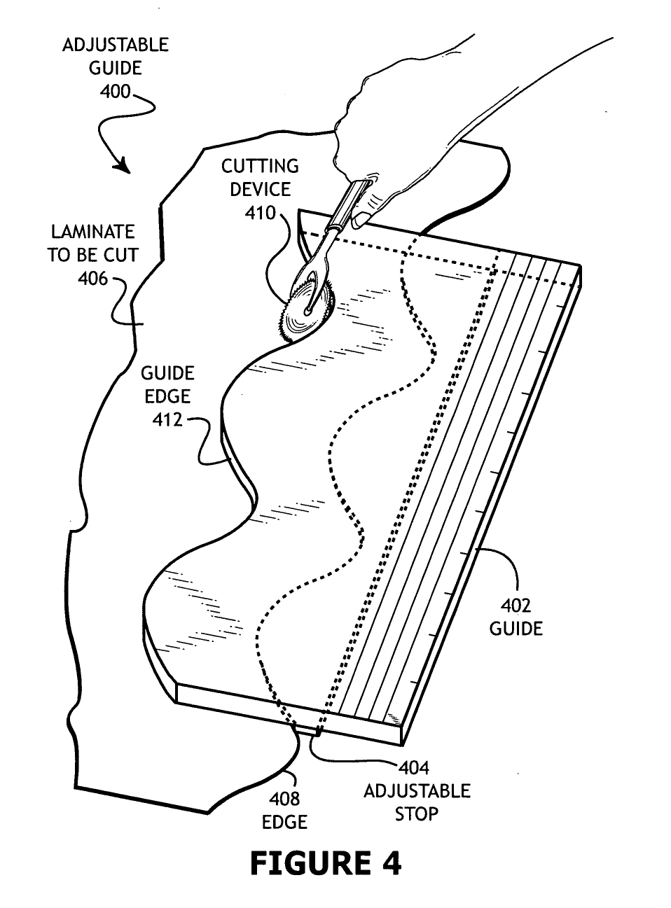

FIG. 4 is a schematic representation of a top view of the embodiment of the adjustable guide 400 of the present invention shown in FIG. 3, hereof. Guide 402 has an adjustable stop 404 attached thereto by static attraction. Laminate material 406 has an edge 408 that has a wavy profile can be aligned with the wavy profile of adjustable stop 404. Cutting device 410 may be moved along the guide edge 412 to mark or cut laminate 406.

Guide 400 allows a user to cut laminate 406 along the curve specified by guide edge 412. The curved edge of adjustable stop 404 is shown as aligning with the curved edge of laminate 406, so reproducible patterns can be generated.

Those skilled in the arts will appreciate that various patterns for guide edge 412 are possible while keeping within the spirit and intent of the present invention.

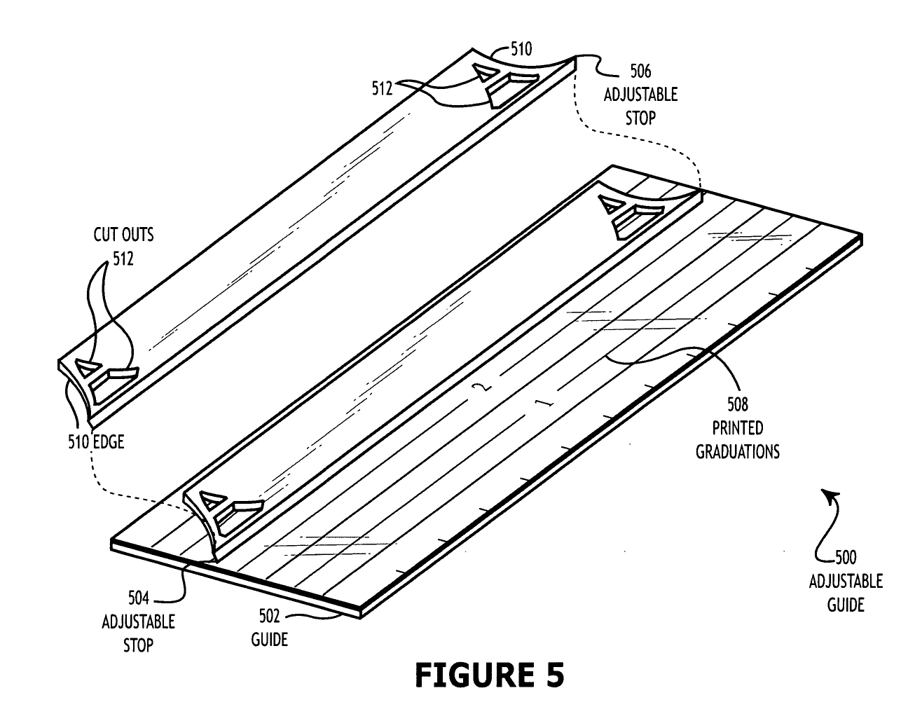

FIG. 5 is a schematic representation of a bottom view of another embodiment 500 of the adjustable guide of the present invention. Guide 502 has an attached adjustable stop 504 (506; shown as removed from guide 502) that may be aligned with graduations 508 on guide 502. Adjustable stop 504 is shown having curved edges 510 and cutouts 512 that may be a rendition of a company's trademark or other aesthetic design unrelated to the shape of the material to be cut using adjustable guide 500.

Various shapes and styles of the adjustable stop 504 and guide 502 may be created by those skilled in the art. Markings on either the top or bottom of guide 502 may be configured for trade dress or advertising purposes, may incorporate instructions that may be used in conjunction with the printed graduations 508 to align stop 504, or for other purposes as needed.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for cutting laminar material comprising:
attaching a stop having an alignment edge to the bottom surface of a guide having a substantially planar bottom surface and a guide edge, at a chosen position;
placing said guide on top of said laminar material;
adjusting the position of said guide such that said alignment edge of said stop engages at least a portion of an edge of said laminar material; and
cutting said laminar material along at least a portion of the guide edge.

2. The method of claim 1, wherein the guide edge is substantially straight.

3. The method of claim 2, wherein the alignment edge of said stop is substantially straight.

4. The method of claim 1, wherein the guide edge has a curved edge.

5. The method of claim 4, wherein the alignment edge of said stop is substantially straight.

6. The method of claim 1, wherein said guide comprises markings visible when said guide is viewed from the bottom surface thereof.

7. The method of claim 1, wherein said guide comprises transparent material.

8. The method of claim 1, wherein said stop comprises polyvinylchloride sheet.

9. The method of claim 1, wherein the thickness of said stop is chosen such that the stop effectively engages the edge of said laminar material.

10. The method of claim 1, wherein said stop is attached to said guide by static attraction.

11. The method of claim 1, wherein said stop is attached to said guide using a releasable adhesive.

12. The method of claim 1, wherein means are provided on said guide for positioning said guide over said laminar material in a chosen orientation during said step of adjusting the position of said guide on said laminar material.

13. An apparatus for guiding a cutting device for laminar material having an edge comprising:
a guide having a substantially planar bottom surface and a guide edge; and
a stop having an alignment edge adapted to align with the edge of said laminar material, wherein said stop is adapted to attach to the bottom surface of said guide at a predetermined position such that at least a portion of the guide edge of said guide is used to guide said cutting device.

14. The apparatus of claim 13, wherein said guide edge is substantially straight.

15. The apparatus of claim 14, wherein said alignment edge of said stop is substantially straight.

16. The apparatus of claim 13, wherein said guide edge has a curved edge.

17. The apparatus of claim 16, wherein said alignment edge of said stop is substantially straight.

18. The apparatus of claim 13, wherein said guide comprises markings, said markings being visible while said guide is viewed from said bottom surface.

19. The apparatus of claim 13, wherein said guide comprises transparent material.

20. The apparatus of claim 13, wherein said stop comprises polyvinylchloride sheet.

21. The apparatus of claim 13, wherein the thickness of said stop is chosen such that the stop effectively engages the edge of said laminar material.

22. The apparatus of claim 13, wherein said stop is attached to said guide using static attraction.

23. The apparatus of claim 13, wherein said stop is attached to said guide using a releasable adhesive.

24. The apparatus of claim 13, further comprising means for positioning said guide over said laminar material.

25. An apparatus for marking laminar material having an edge comprising:
a guide having a substantially planar bottom surface and a marking edge;
a stop having an alignment edge adapted to align with the edge of said laminar material, wherein said stop is adapted to attach to the bottom surface of said guide at a predetermined position; and
means for marking said laminar material, wherein at least a portion of the marking edge of said guide is used to guide said means for marking said laminar material.

26. The apparatus of claim 25, wherein said marking edge is substantially straight.

27. The apparatus of claim 26, wherein said alignment edge of said stop is substantially straight.

28. The apparatus of claim 25, wherein said marking edge has a curved edge.

29. The apparatus of claim 28, wherein said alignment edge of said stop is substantially straight.

30. The apparatus of claim 25, wherein said guide comprises markings, said markings being visible while said guide is viewed from said bottom surface.

31. The apparatus of claim 25, wherein said guide comprises transparent material.

32. The apparatus of claim 25, wherein said stop comprises polyvinylchloride sheet.

33. The apparatus of claim 25, wherein the thickness of said stop is chosen such that the stop effectively engages the edge of said laminar material.

34. The apparatus of claim 25, wherein said stop is attached to said guide using static attraction.

35. The apparatus of claim 25, wherein said stop is attached to said guide using a releasable adhesive.

36. The apparatus of claim 25, further comprising means for positioning said guide over said laminar material.
